(19) United States
(12) Patent Application Publication
(10) Pub. No.: US 2016/0094752 A1
(43) Pub. Date: Mar. 31, 2016

(54) Image Forming Apparatus That Reduces Waste Paper Sheet

(71) Applicant: Kyocera Document Solutions Inc., Osaka (JP)

(72) Inventors: Hitoshi Asaka, Osaka (JP); Hironori Daigo, Osaka (JP)

(21) Appl. No.: 14/872,041

(22) Filed: Sep. 30, 2015

(30) Foreign Application Priority Data
Sep. 30, 2014 (JP) 2014-200468
Jul. 31, 2015 (JP) 2015-152013

(51) Int. Cl. H04N 1/32; H04N 1/00; B65H 1/04; B65H 7/20; B65H 7/06

(52) U.S. Cl. CPC H04N 1/3263; B65H 7/20; B65H 7/06; B65H 1/04; H04N 1/00588; H04N 1/00689; H04N 1/00692; H04N 1/32667; H04N 2201/0094

(57) ABSTRACT

An image forming apparatus includes a conveyance path, a print stop unit, a solution operation detector, a jam solution confirming unit, and a continuous printing resuming unit. The print stop unit stops an image forming operation when a preliminary specified print stop condition is met at a start of the continuous printing or during execution of the continuous printing. The jam solution confirming unit determines whether one sheet is normally conveyed or not by a confirmation conveyance operation. The confirmation conveyance operation conveys the sheet in the conveyance path after stopping the image forming operation by the print stop unit. The continuous printing resuming unit resumes the continuous printing by a usual conveying operation. The continuous printing simultaneously conveys a plurality of sheets in the conveyance path when the jam solution confirming unit determines that the sheets are normally conveyed.

### INCORPORATION BY REFERENCE

This application is based upon, and claims the benefit of priority from, corresponding Japanese Patent Application No. 2014-200468 filed in the Japan Patent Office on Sep. 30, 2014 and Japanese Patent Application No. 2015-152013 filed in the Japan Patent Office on Jul. 31, 2015, the entire contents of which are incorporated herein by reference.

### BACKGROUND

Unless otherwise indicated herein, the description in this section is not prior art to the claims in this application and is not admitted to be prior art by inclusion in this section.

Recently, a multifunction peripheral (MFP) having a function such as a scanner, a facsimile, a printer, or a copier is widely used in offices and a similar place. The multifunction peripheral is in many cases used, for example, in a state where the multifunction peripheral is connected to an information processing terminal, such as a personal computer, via a network such as a local area network (LAN).

Such multifunction peripheral widely employs a configuration of including a plurality of sheet feed cassettes. The sheet feed cassettes each house, for example, a plurality of types of paper sheets of different sizes. The multifunction peripheral, which includes the plurality of sheet feed cassettes, has a long distance from the sheet feed cassettes to an image forming position (an imaging position), which is a position where an image is formed on a paper sheet. Accordingly, for example, in the configuration that starts conveying a subsequent paper sheet from the sheet feed cassette after completion of image formation at the image forming position, standby time corresponding to time required for the subsequent paper sheet to arrive at the image forming position occurs. This lengthens printing process time.

To reduce such standby time for conveying the paper sheets during continuous printing, a conveying method to cause the plurality of paper sheets to stand by at a conveyance path for paper sheets is employed. For example, while forming an image on a preceding paper sheet at an image forming position, the subsequent paper sheet is conveyed to a registration roller, which sends out the paper sheet to the image forming position according to image formation timing. Furthermore, some large-sized machines with long conveyance path conveys a further subsequent paper sheet to a predetermined position upstream of the subsequent paper sheet that stands by at the registration roller and causes the further subsequent paper sheet to stands by at the predetermined position.

If the paper sheet is jammed in the above-described multifunction peripheral, which causes the plurality of paper sheets to stand by at the conveyance path, all the paper sheets in the conveyance path need to be removed. In this case, if the paper sheets to be removed remains although the user has intended to remove all the paper sheets, the removal of the paper sheets is requested again.

As this countermeasure, the following image forming apparatus has been disclosed. When a jam occurs, a count of jammed paper sheets accumulated in the conveyance path is output by audio. Thus, the image forming apparatus notifies the user of the count of paper sheets to be removed.

### SUMMARY

An image forming apparatus according to one aspect of the disclosure includes a conveyance path, a print stop unit, a jam solution confirming unit, and a continuous printing resuming unit. The conveyance path simultaneously conveys a plurality of sheets for printing in continuous printing. The print stop unit stops an image forming operation when a preliminary specified print stop condition is met at a start of the continuous printing or during execution of the continuous printing. The jam solution confirming unit determines whether one sheet is normally conveyed or not by a confirmation conveyance operation. The confirmation conveyance operation conveys the sheet in the conveyance path after stopping the image forming operation by the print stop unit. The continuous printing resuming unit resumes the continuous printing by a usual conveying operation. The continuous printing simultaneously conveys a plurality of sheets in the conveyance path when the jam solution confirming unit determines that the sheets are normally conveyed.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates an overall configuration of a multifunction peripheral according to one embodiment of the disclosure.

FIG. 2 illustrates a hardware configuration of the multifunction peripheral according to one embodiment.

FIG. 3 illustrates the multifunction peripheral according to one embodiment.

FIG. 4 illustrates an example of an image formation resuming process after a sheet jam performed by the multifunction peripheral according to one embodiment.

FIG. 5 illustrates a function block diagram showing another multifunction peripheral according one embodiment of the disclosure.

FIG. 6 shows an example of a flowchart of an image formation procedure performed by another multifunction peripheral according to one embodiment of the disclosure.

FIG. 7 illustrates a function block diagram showing yet another multifunction peripheral according one embodiment of the disclosure.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The following describes one embodiment of the disclosure in more detail with reference to the drawings. The following embodies the disclosure as a digital multifunction peripheral.

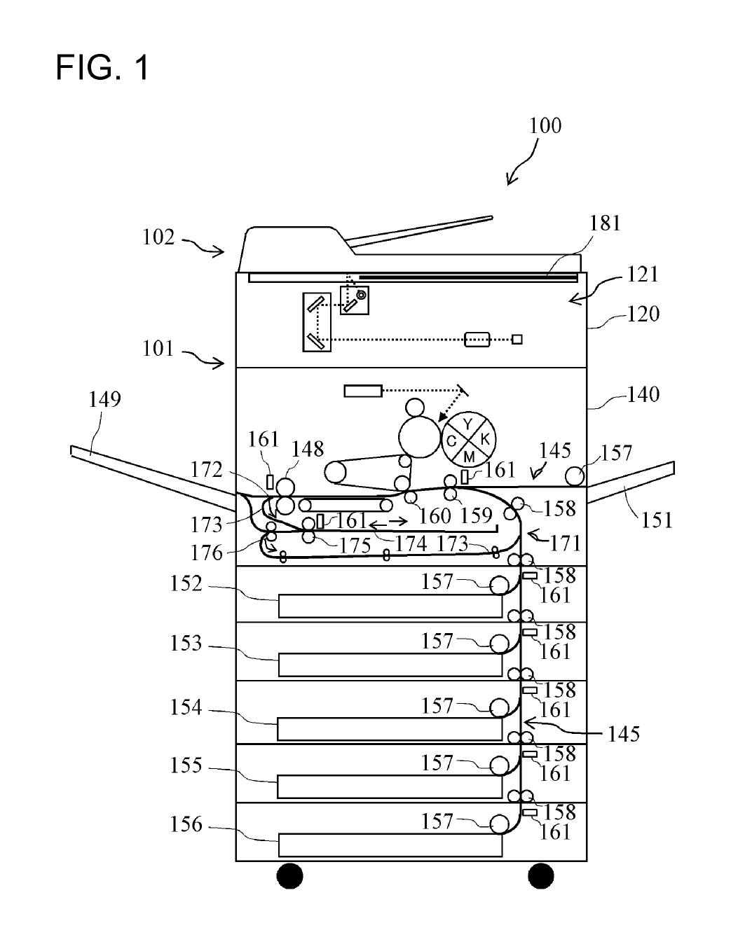

FIG. 1 illustrates an exemplary overall configuration of the digital multifunction peripheral in the embodiment. As illustrated in FIG. 1, a multifunction peripheral 100 includes a main body 101 including an image reading unit 120 and an image forming unit 140 and a platen cover 102 mounted over the main body 101. The multifunction peripheral 100 includes an operation panel 181 at its front face where a user can provide instructions of a start of copying and other instructions to the multifunction peripheral 100 and check a state and a setting of the multifunction peripheral 100.

In the upper portion of the main body 101, the image reading unit 120 is located. The image reading unit 120 reads an image of a document by a scanning optical system 121 and generates digital data (image data) of the image.

The generated image data can be printed on a paper sheet (a sheet) in the image forming unit 140. The generated image data can be also transmitted to other devices through a network via a network interface (not illustrated) or a similar interface.

The image forming unit 140 prints the image data generated by the image reading unit 120 and the image data received from another device connected to the network on the paper sheet. The image forming unit 140 feeds a paper sheet to a transfer unit 160 transferring a toner image from a manual bypass tray 151, sheet feed cassettes 152, 153, 154, 155, 156, and a similar tray. The manual bypass tray 151 and the respective sheet feed cassettes 152, 153, 154, 155, and 156 can place or house the paper sheets of various sizes. The image forming unit 140 selects a paper sheet specified by the user and a paper sheet corresponding to a document size automatically detected. The image forming unit 140 feeds the selected paper sheet from the manual bypass tray 151 and the sheet feed cassettes 152, 153, 154, 155, and 156 by a feed roller 157. The fed paper sheet is conveyed through a conveyance path 145. Conveyance rollers 158 and a registration roller 159, which are disposed at the conveyance path 145, convey the paper sheet to the transfer unit 160. The paper sheet on which the toner images have been transferred is conveyed to a fuser 148. The fuser 148 fixes the toner images on the paper sheet with heat and pressing force. The paper sheet that has passed the fuser 148 is discharged to a sheet discharge tray 149.

The image forming unit 140 includes an inverting portion 171, which inverts the paper sheet for duplex printing. The inverting portion 171 includes a branching portion 172, an inversion paper sheet conveyance passage 173, an intermediate tray 174 (a sheet holding portion), a switchback mechanism 175, and a paper sheet inverting mechanism 176. The branching portion 172 is disposed on the paper discharge side of the fuser 148. The branching portion 172 guides the paper sheet to the inversion paper sheet conveyance passage 173 of the inverting portion 171. The intermediate tray 174 is disposed in the middle of the inversion paper sheet conveyance passage 173. The paper sheet guided by the branching portion 172 to which one-sided printing has been completed is temporarily discharged to the intermediate tray 174. The switchback mechanism 175 inverts the conveyance direction of the paper sheet discharged to the intermediate tray 174 and introduces the paper sheet to the inversion paper sheet conveyance passage 173. The paper sheet inverting mechanism 176 inverts the surface of the paper sheet re-introduced to the inversion paper sheet conveyance passage 173 by the switchback mechanism 175. Then, the paper sheet inverting mechanism 176 feeds this paper sheet to the registration roller 159. This inverting portion 171 ensures duplex printing, which performs printing on the respective front surface and back surface of the paper sheet. The above-described conveyance path 145 includes a conveyance path for paper sheet constituting the inverting portion 171. The well-known configuration related to the duplex printing is applicable to the inverting portion 171.

At the conveyance path 145, sheet detection sensors 161 are disposed at specific positions, such as near the conveyance rollers 158 and the registration roller 159 (here, near the upstream side). The sheet detection sensor 161 detects whether the paper sheet is present at the corresponding position in the conveyance path 145 or not. The sheet detection sensor 161 can be constituted of a contactless sensor such as a reflective photo sensor (a photo reflector) and a transmissive photo sensor (a photo interrupter). In the reflective photo sensor, a light emitting portion and a light receiving portion are disposed on one surface. In the transmissive photo sensor, the light emitting portion is disposed opposed to the light receiving portion. A contact type sensor, such as a micro switch, that includes an actuator is also applicable.

The multifunction peripheral 100 continuously conveys a plurality of paper sheets in the conveyance path 145 during the continuous printing. For example, to perform single-sided printing continuously across a plurality of pages using the paper sheets housed in the lowest sheet feed cassette 156, when the first paper sheet passes through the sheet detection sensor 161 disposed near the downstream of the feed roller 157, the second paper sheet is extracted from the sheet feed cassette 156 at a predetermined timing. When the first paper sheet arrives at the registration roller 159, this second paper sheet is held in a state of being sandwiched by the conveyance roller 158 (For example, the conveyance roller 158 is closest to and at the upstream of a join portion. This join portion is the join portion of the conveyance path 145 heading from the sheet feed cassettes 152 to 156 to the registration roller 159 and the conveyance path 145 heading from the inverting portion 171 to the registration roller 159) disposed at the conveyance path 145 on the upstream with respect to the rear end of the paper sheet previously fed. In this case, two paper sheets are accumulated in the conveyance path 145.

When the first paper sheet is sent out from the registration roller 159 to the transfer unit 160, the second paper sheet is held in a state where the distal end of the paper sheet arrives at the registration roller 159. At this time, the third paper sheet has already been extracted from the sheet feed cassette 156 to the conveyance path 145. This third paper sheet is held in the state of being sandwiched by the conveyance roller 158 by which the second paper sheet was held. In this case, three paper sheets are accumulated in the conveyance path 145.

To perform the duplex printing continuously across a plurality of pages using the paper sheets housed in the lowest sheet feed cassette 156, when the first paper sheet passes through the sheet detection sensor 161 disposed near the downstream of the feed roller 157, the second paper sheet is extracted from the sheet feed cassette 156. When the first paper sheet arrives at the registration roller 159, similar to the single-sided printing, this second paper sheet is held by the conveyance roller 158 closest to and at the upstream of this join portion with the inverting portion 171.

When the first paper sheet is sent out from the registration roller 159 to the transfer unit 160, the second paper sheet is held in a state where the distal end of the paper sheet arrives at the registration roller 159. At this time, the third paper sheet has already been extracted from the sheet feed cassette 156 to the conveyance path 145. This third paper sheet is held in the state of being sandwiched by the conveyance roller 158 by which the second paper sheet was held. After the image of the first page is transferred by the transfer unit 160, the first paper sheet is introduced to the inversion paper sheet conveyance passage 173 and then is held at the intermediate tray 174.

When the second paper sheet is sent out from the registration roller 159 to the transfer unit 160, the first paper sheet held at the intermediate tray 174 is conveyed to the inversion paper sheet conveyance passage 173 by the switchback mechanism 175 of the paper sheet inverting mechanism 176 and is held. Concurrently, the third paper sheet is held in a state of being sandwiched by the registration roller 159. At this time, the fourth paper sheet has already been extracted from the sheet feed cassette 156 to the conveyance path 145. This fourth paper sheet is held in a state of being sandwiched by the conveyance roller 158 by which the third paper sheet was held. After the transfer unit 160 transfers the image of the third page, the second paper sheet is introduced to the inversion paper sheet conveyance passage 173 and then is discharged to the intermediate tray 174.

When the third paper sheet is sent out from the registration roller 159 to the transfer unit 160, the conveyance roller 158 sandwiches the subsequent paper sheet (here, the fourth paper sheet) and continues holding the paper sheet. At this time, the first paper sheet is transmitted from the inversion paper sheet conveyance passage 173 to the registration roller 159. After the transfer unit 160 transfers the image of the second page (the image that should be printed on the opposite surface of the first page), this first paper sheet is discharged to the sheet discharge tray 149. When the first paper sheet is sent out from the registration roller 159 to the transfer unit 160, the second paper sheet held at the intermediate tray 174 is conveyed to the inversion paper sheet conveyance passage 173 by the switchback mechanism 175 of the paper sheet inverting mechanism 176 and is held. Concurrently, the fourth paper sheet is held in the state of being sandwiched by the registration roller 159. At this time, the fifth paper sheet has already been extracted from the sheet feed cassette 156 to the conveyance path 145. This fifth paper sheet is held in the state of being sandwiched by the conveyance roller 158 by which the fourth paper sheet was held. Thus, in the process of forming the image on the back surface of the first paper sheet, the four paper sheets are accumulated in the conveyance path 145.

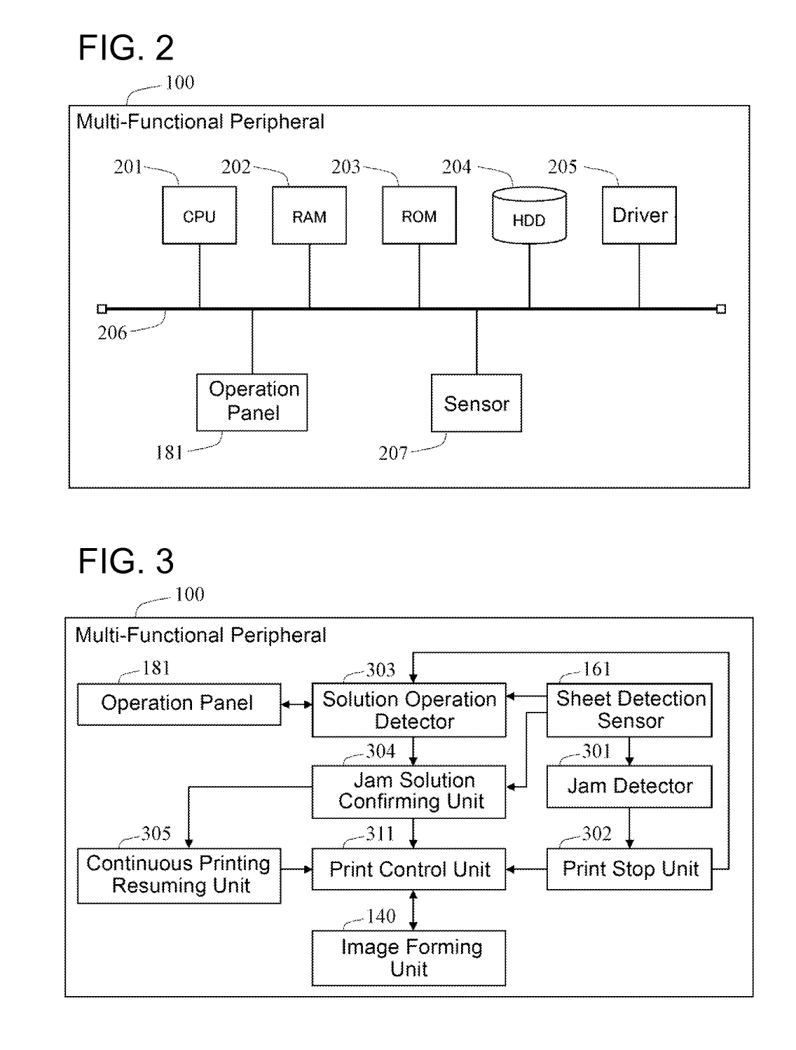

FIG. 2 illustrates a hardware configuration of a control system in the multifunction peripheral 100. In the multifunction peripheral 100 in the embodiment, a central processing unit (CPU) 201, a random access memory (RAM) 202, a read only memory (ROM) 203, a hard disk drive (HDD) 204, and a driver 205 corresponding to respective driving units in the image reading unit 120 and the image forming unit 140 are connected via an internal bus 206. The ROM 203, the HDD 204, and a similar memory store programs, and the CPU 201 controls the multifunction peripheral 100 in accordance with instructions of the control programs. For example, the CPU 201, which uses the RAM 202 as a work area, controls operations of the respective driving units by transmission and reception of data and instructions with the driver 205. The HDD 204 is also used to accumulate the image data acquired by the image reading unit 120 and the image data received from the other devices via the network.

To the internal bus 206, the operation panel 181 and various kinds of sensors 207 are also connected. The operation panel 181 accepts an operation by a user and supplies a signal based on the operation to the CPU 201. The operation panel 181 displays an operation screen in its display in accordance with a control signal from the CPU 201. The sensors 207 includes various kinds of sensors, such as an open and close detection sensor of the platen cover 102, a document detection sensor on a platen 103, a temperature sensor of the fuser 148, and the above-described sheet detection sensor 161.

The CPU 201 ensures respective units (function blocks) in the following and controls the operations of the respective units corresponding to the signals from these sensors by executing the programs stored, for example, in the ROM 203.

FIG. 3 illustrates the multifunction peripheral according to the embodiment. As illustrated in FIG. 3, the multifunction peripheral 100 of this embodiment includes a jam detector 301, a print stop unit 302, a solution operation detector 303, a jam solution confirming unit 304, a continuous printing resuming unit 305, and a print control unit 311.

The print control unit 311 controls execution of an image formation process in the multifunction peripheral 100 (the image forming unit 140). That is, the print control unit 311 performs printing of image data by the image forming unit 140 based on an image forming instruction by the user through the operation panel 181, the image forming instruction input through a network, a facsimile reception instruction input through a public network, or a similar instruction.

The jam detector 301 detects the sheet jam in the conveyance path 145 based on detection results of the plurality of sheet detection sensors 161, which are disposed in the conveyance path 145. For example, after the sheet detection sensor 161 enters in a detected state (A paper sheet is present), if the sheet detection sensor 161 does not enter a no-detection state (The paper sheet is absent) after the elapse of specified time preset to each sheet detection sensor 161, the jam detector 301 determines that the sheet has been jammed at the detection position of the sheet detection sensor 161. As the specified time, different values can be set depending on the size of the paper sheet conveyed through the conveyance path 145.

When the jam detector 301 detects the sheet jam, the print stop unit 302 stops the image forming operation. As described above, with this embodiment, the print control unit 311 controls the image formation process in the image forming unit 140. Accordingly, in this embodiment, the print stop unit 302 inputs a print stop instruction to the print control unit 311 to stop the image forming operation by the image forming unit 140.

The solution operation detector 303 detects the completion of a solution operation for sheet jam by the user. Although not specifically limited, in this embodiment, when the solution operation detector 303 detects that the sheet detection sensor 161, which had detected the sheet jam, enters in the no-detection state and an open/close door, which needs to be opened to remove the paper sheet accumulated in the image forming unit 140, such as the paper sheet accumulated at a position corresponding to this sheet detection sensor 161 in the conveyance path 145, of the main body 101 changes from the open state to the closed state, it is determined that the user has completed the solution operation for sheet jam. The contact type sensor or a similar sensor can easily detect the open/closed state of the open/close door of the main body 101.

When the solution operation detector 303 detects the completion of the solution operation, the jam solution confirming unit 304 determines whether this paper sheet is normally conveyed or not by a confirmation conveyance operation. The confirmation conveyance operation conveys the one paper sheet in the conveyance path. As described above, with this embodiment, the print control unit 311 controls the image formation process in the image forming unit 140. Accordingly, in this embodiment, the jam solution confirming unit 304 inputs a conveyance instruction for only the one paper sheet to the print control unit 311, thus achieving the confirmation conveyance operation. Although not specifically limited, in this embodiment, the jam solution confirming unit 304 conveys the paper sheets in the confirmation conveyance operation at a speed lower than a sheet conveyance speed in the usual conveying operation.

The jam solution confirming unit 304 can determine whether the paper sheet is normally conveyed or not as follows. For example, when the confirmation conveyance operation conveys the one paper sheet to the sheet discharge tray 149, the jam solution confirming unit 304 determines that the paper sheet is normally conveyed. The following configuration can also be employed. In the confirmation conveyance operation, when the paper sheet passes through the detection position of the sheet detection sensor 161 where the sheet jams, which had been detected by the jam detector 301, the jam solution confirming unit 304 determines that the paper sheet is normally conveyed.

When the jam solution confirming unit 304 determines the normal conveyance, the continuous printing resuming unit 305 resumes the continuous printing by the usual conveying operation. The usual conveying operation simultaneously conveys the plurality of paper sheets in the conveyance path 145. In this embodiment, the continuous printing resuming unit 305 inputs a resumption instruction of the continuous printing to the print control unit 311, thus achieving the usual conveying operation.

Although not specifically limited, in this embodiment, in the confirmation conveyance operation, the jam solution confirming unit 304 forms the image related to the print job stopped by the print stop unit 302 on the paper sheet. For example, when the multifunction peripheral 100 performs a print job of the image data of all 20 pages and the printing has been normally completed up to the tenth page, the confirmation conveyance operation prints the image data on the 11th page. In this case, in the subsequent usual conveying operation, the continuous printing is performed from the 12th page to the 20th page. The image data whose printing has been normally completed can be easily specified by the positions of each paper sheet at the time point of the sheet jam.

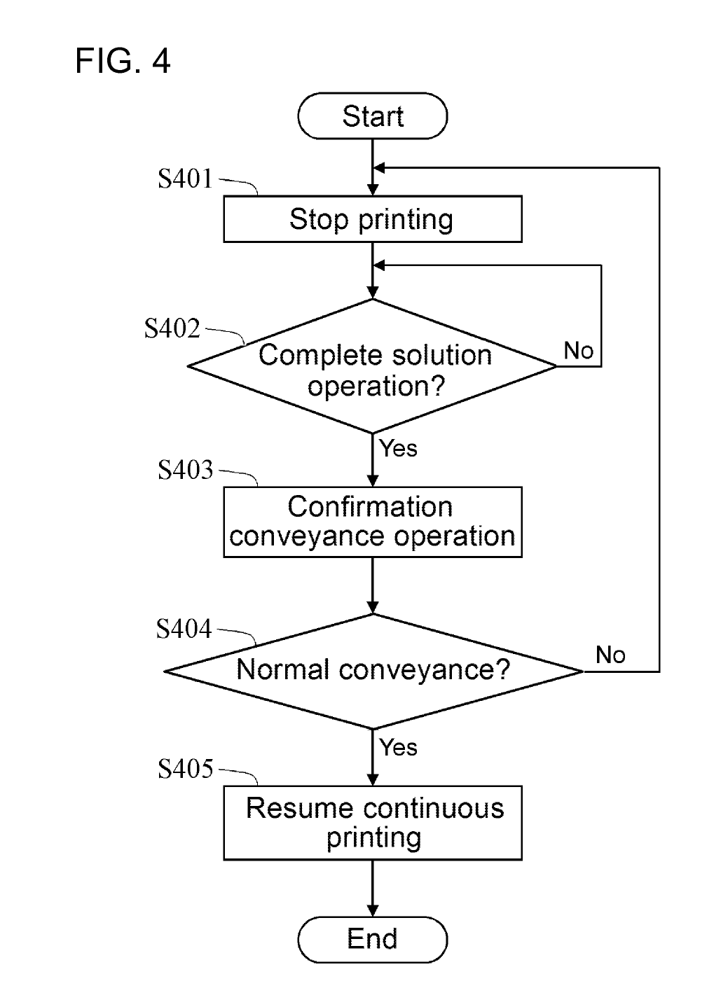

FIG. 4 illustrates an example of an image formation resuming process after a sheet is jammed performed by the multifunction peripheral 100. For example, the detection of the sheet jam in the conveyance path 145 by the jam detector 301 triggers the start of this procedure.

The jam detector 301 that has detected the sheet jam in the conveyance path 145 notifies the print stop unit 302 of the fact. According to this notification, the print stop unit 302 stops the image forming operation by the image forming unit 140 by the above-described method (Step S401). At this time, the print stop unit 302 notifies the fact that the image forming operation has been stopped to the solution operation detector 303.

According to this notification, the solution operation detector 303 requests the removal of all the paper sheets accumulated in the conveyance path 145 in addition to the paper sheet causing the sheet jam to the user. Although not specifically limited, in this embodiment, at this time, the solution operation detector 303 displays a guidance screen indicative of the position and the removal method of the paper sheet causing the sheet jam and a guidance screen indicative of the position and the removal method of other paper sheets on a display provided with the operation panel 181 in this order (No at Step S402). Afterwards, when the solution operation detector 303 detects the completion of the solution operation for sheet jam by the user as described above, the solution operation detector 303 notifies the jam solution confirming unit 304 of the fact (Yes at Step S402).

The jam solution confirming unit 304 performs the confirmation conveyance operation according to this notification (Step S403). In the case of the stopped print job being the duplex printing, the confirmation conveyance operation immediately carries out the paper sheet carried in the intermediate tray 174. Subsequent to printing of one surface, the other surface is printed.

When the jam solution confirming unit 304 can confirm the normal conveyance in the confirmation conveyance operation, the jam solution confirming unit 304 notifies the continuous printing resuming unit 305 of the fact (Yes at Step S404). According to this notification, the continuous printing resuming unit 305 resumes the continuous printing in the usual conveying operation (Step S405). As described above, in the confirmation conveyance operation, the normal conveyance can be determined when the one paper sheet is discharged to the sheet discharge tray 149 and the one paper sheet passes through the detection position of the sheet detection sensor 161 where the sheet jam had been detected by the jam detector 301.

Meanwhile, if the paper sheet cannot be normally conveyed in the confirmation conveyance operation, the jam detector 301 detects the sheet jam again. In this case, the procedure proceeds from the stop of the image forming operation by the print stop unit 302 again (No at Step S404, S401).

While in the embodiment describes the case where the intermediate tray 174, which house the one paper sheet whose one surface has been printed, is provided as the sheet holding portion, the following configuration ensuring a so-called batch processing may be employed. In this configuration, the sheet holding portion houses the plurality of paper sheets whose one surfaces have been printed, the other surfaces of the plurality of paper sheets, which are housed in this sheet holding portion, are continuously printed.

As described above, immediately after the completion of the solution operation for sheet jam by the user, this multifunction peripheral 100 does not immediately start the usual conveying operation. However, the multifunction peripheral 100 performs the confirmation conveyance operation that conveys the one paper sheet in the conveyance path 145. Accordingly, provisionally, even if a slip of paper or a similar paper undetectable by the sheet detection sensor 161 is accumulated, the paper sheet that becomes waste when the sheet jam occurs again is only the paper sheet conveyed by the confirmation conveyance operation. Accordingly, even if the paper sheet removal is imperfect and the jam occurs again, the waste paper sheets can be reduced.

Even in the confirmation conveyance operation, when the sheet jam has been normally solved to print the image data related to the stopped print job, the multifunction peripheral 100 can obtain the normal printed matter.

In the above-described multifunction peripheral 100, the configuration that stops the image forming operation upon detection of sheet jam and performs the confirmation conveyance operation after completion of the solution operation for sheet jam by the user is described. However, to minimize the waste paper sheets, it is preferable to stop the image forming operation also when a possibility of occurrence of sheet jam is high, not limited to the occurrence of sheet jam. For example, when humidity is high and when the paper sheets housed in the sheet feed cassettes 152 to 156 are not used over a long period of time, a curling and waviness may occur in the paper sheets. Conveying the paper sheet in such a state increases the possibility of sheet jam in the conveyance path 145.

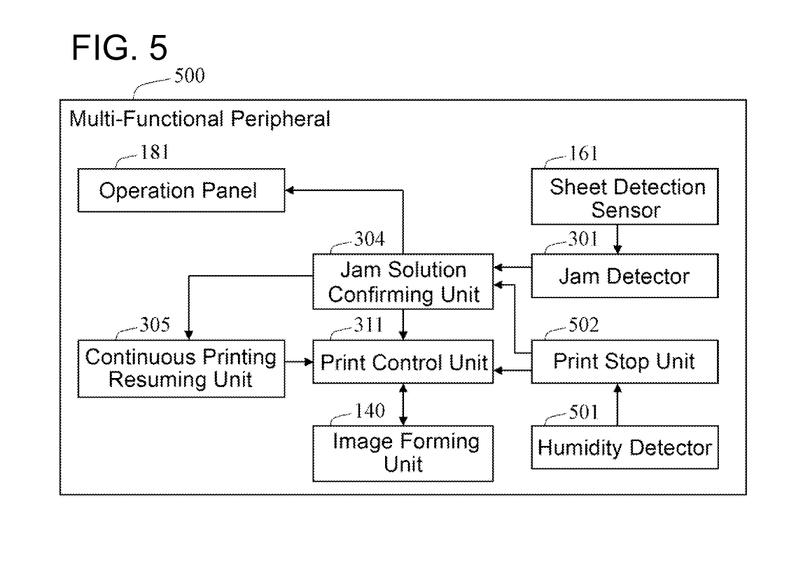

The following describes the multifunction peripheral that stops the image forming operation under a situation where the sheet jam is more likely to occur and performs the confirmation conveyance operation according to this stop. FIG. 5 illustrates a function block diagram showing another multifunction peripheral according the embodiment. A multifunction peripheral 500 has a configuration that supports a high humidity situation where the sheet jam is more likely to occur. In FIG. 5, like reference numerals are designated to components providing operational effects similar to the components of the multifunction peripheral 100, and therefore these elements will not be further elaborated in the following. As illustrated in FIG. 5, this multifunction peripheral 500 differs from the multifunction peripheral 100 in that the multifunction peripheral 500 includes a humidity detector 501 and a print stop unit 502. The print stop unit 502 stops the image forming operation in response to a detection result by this humidity detector 501.

The humidity detector 501 detects an atmosphere humidity of the multifunction peripheral 500. The atmosphere humidity can be obtained by, for example, a known humidity sensor. Upon detection of high humidity equal to or more than a reference humidity preliminarily specified by the humidity detector 501, the print stop unit 502 stops the image forming operation. Although not specifically limited, in this embodiment, as the reference humidity, “80%” has been preliminary registered with the print stop unit 502.

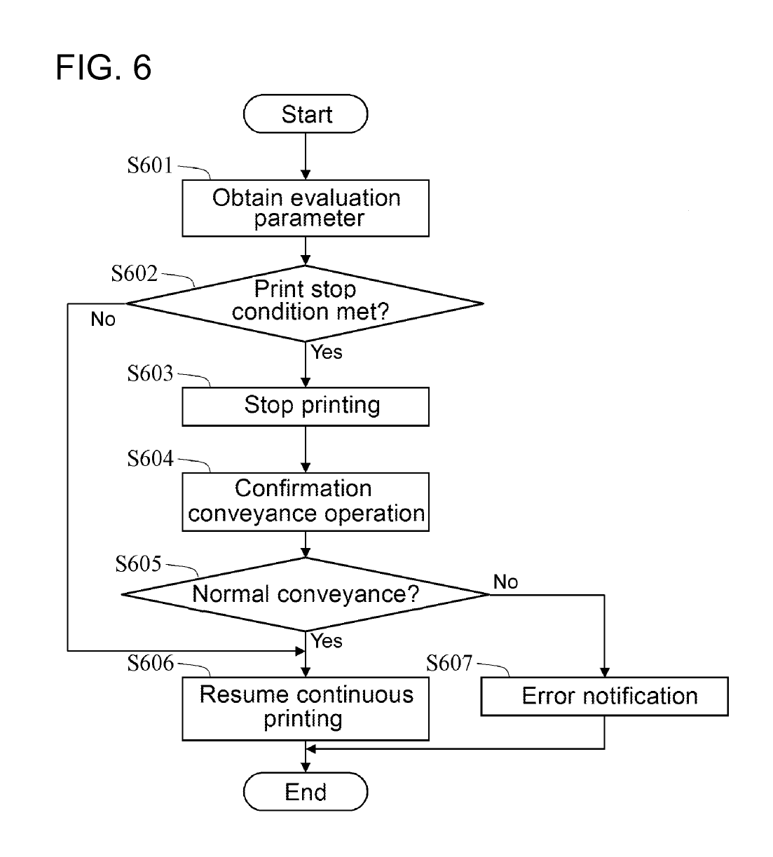

FIG. 6 is a flowchart showing an example of an image formation procedure performed by the multifunction peripheral 500. This procedure starts, for example, triggering an input of a print instruction to the multifunction peripheral 500. When this procedure starts, the print stop unit 502 obtains the atmosphere humidity as an evaluation parameter to determine whether a print stop condition is met or not from the humidity detector 501 (Step S601). Then, the print stop unit 502 determines whether the obtained atmosphere humidity is equal to or more than the reference humidity (here, 80%) or not (Step S602). When the obtained atmosphere humidity is less than the reference humidity, the print stop unit 502 does not stop the image forming operation by the image forming unit 140 (No at Step S602). Accordingly, the image forming unit 140 performs printing without change (Step S606).

If the obtained atmosphere humidity is equal to or more than the reference humidity, the print stop unit 502 stops the image forming operation by the image forming unit 140 by the above-described method (Yes at Step S602, S603). At this time, the print stop unit 502 notifies the jam solution confirming unit 304 of the stop of the image forming operation.

In response to this notification, the jam solution confirming unit 304 performs the confirmation conveyance operation (Step S604). Although not specifically limited, in this embodiment, at this time, the jam solution confirming unit 304 causes a display, which is provided with the operation panel 181, to display a message indicating the confirmation conveyance operation being in execution due to the detection of high humidity. Similar to the above-described multifunction peripheral 100, this confirmation conveyance operation may print the image data related to the stopped print job.

When the jam solution confirming unit 304 can confirm the normal conveyance in the confirmation conveyance operation, the jam solution confirming unit 304 notifies the continuous printing resuming unit 305 of the fact (Yes at Step S605). According to this notification, the continuous printing resuming unit 305 resumes (starts) the continuous printing in the usual conveying operation (Step S606).

Meanwhile, if the paper sheet cannot be normally conveyed in the confirmation conveyance operation, the jam detector 301 detects the sheet jam. In this case, the jam solution confirming unit 304 causes the display, which is provided with the operation panel 181, to display a message indicating the failure of normal conveyance of the paper sheet caused by high humidity (No at Step S605, S607). In this case, the user takes a countermeasure such as use of a new paper sheet not containing humidity.

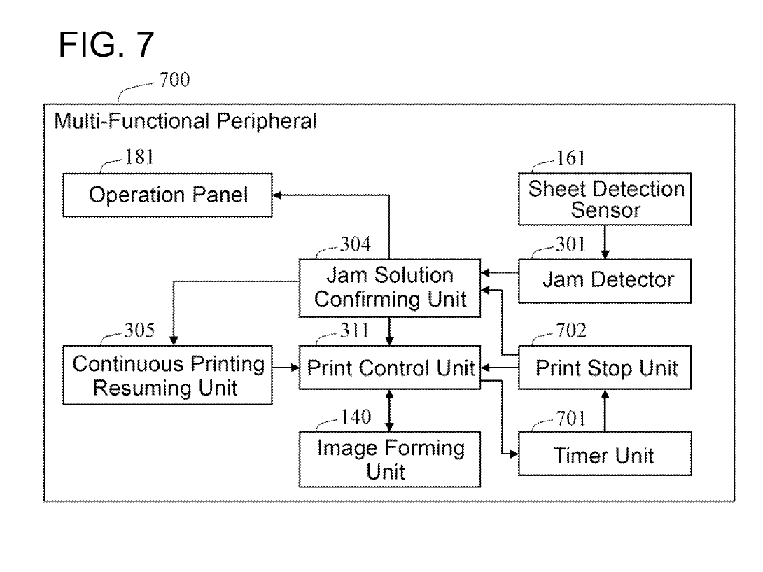

FIG. 7 illustrates a function block diagram showing yet another multifunction peripheral according the embodiment. A multifunction peripheral 700 has a configuration that supports a situation where the paper sheets have not been used over a long period of time under which the sheet jam is more likely to occur. In FIG. 7, like reference numerals are designated to components providing operational effects similar to the components of the multifunction peripheral 100 and the multifunction peripheral 500, and therefore these elements will not be further elaborated in the following. As illustrated in FIG. 7, this multifunction peripheral 700 differs from the multifunction peripheral 100 and the multifunction peripheral 500 in that the multifunction peripheral 700 includes a timer unit 701 and a print stop unit 702. The print stop unit 702 stops the image forming operation in response to a detection result by this timer unit 701.

The timer unit 701 measures a time length of unused paper sheet housed in the sheet feed cassette. The unused time length can be measured as follows. The print control unit 311, for example, sets time when the paper sheets in the sheet feed cassettes 152 to 156 are used last as a calculation starting point. Although not specifically limited, in this embodiment, the timer unit 701 holds time information when the paper sheets in the respective sheet feed cassettes 152 to 156 are used last. The timer unit 701 calculates a difference between time information at the time point of evaluation and the held time information on the sheet feed cassettes target for the determination. Thus, the unused time length is measured.

Upon detection of the unused time equal to or more than the reference time preliminary specified by the timer unit 701, the print stop unit 702 stops the image forming operation that uses the paper sheets in the corresponding sheet feed cassette. Although not specifically limited, in this embodiment, as the reference time, “one week (a counter value corresponding to one week)” is preliminary registered with the print stop unit 702.

The image formation procedure performed by the multifunction peripheral 700 only differs in that the print stop unit 702 obtains the unused time length from the timer unit 701 as the evaluation parameter. Otherwise, the image formation procedure is similar to the flowchart shown in FIG. 6.

As described above, when the image forming operation is stopped due to meeting the print stop condition preliminarily specified, the above-described multifunction peripherals 500 and 700 do not immediately start the usual conveying operation but performs the confirmation conveyance operation, which conveys one paper sheet in the conveyance path. Therefore, provisionally, even if the sheet jam occurs in the confirmation conveyance operation, the waste paper sheet is only the one paper sheet conveyed by the confirmation conveyance operation. Accordingly, even if the sheet jam occurs, the waste paper sheets can be minimized.

As the situation where the possibility of the sheet jam is high, the high humidity and the unused paper sheets over a long period of time are exemplified above. However, as long as the situations can be preliminarily set to the print stop unit as the print stop conditions, any other evaluation parameters may be employed.

The above-described respective embodiments do not limit the technical scope of the disclosure. Various modifications and applications are possible within the scope of the disclosure in addition to the already-described embodiments. For example, the embodiment exemplifies the image forming apparatus using electrophotographic method. However, the disclosure is also applicable to an image forming apparatus using an inkjet printing method.

With the embodiment, the confirmation conveyance operation also prints the images related to the stopped print job. However, the confirmation conveyance operation may only convey the paper sheets without performing printing. In this case, when the stopped print job is the duplex printing, the configuration that only conveys the paper sheets also in the inverting portion 171 can be employed. When the detection position of the sheet detection sensor 161 where the sheet jam had been detected by the jam detector 301 is not in the inverting portion 171, even if the duplex printing is specified for the print job, the confirmation conveyance operation can also employ a configuration that causes the one paper sheet not to pass through the inverting portion 171.

Furthermore, the above-described embodiment embodies the disclosure as the digital multifunction peripheral. However, this should not be limited to this apparatus. The disclosure is also applicable to any image forming apparatus such as a facsimile and a copier.

According to the disclosure, even if the paper sheet is not perfectly removed and the paper jam occurs again, the waste paper sheets can be reduced, effective as the image forming apparatus.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An image forming apparatus comprising:
a conveyance path that simultaneously conveys a plurality of sheets for printing in continuous printing;
a print stop unit that stops an image forming operation when a preliminary specified print stop condition is met at a start of the continuous printing or during execution of the continuous printing;
a jam solution confirming unit that determines whether one sheet is normally conveyed or not by a confirmation conveyance operation, the confirmation conveyance operation conveying the sheet in the conveyance path after stopping the image forming operation by the print stop unit; and
a continuous printing resuming unit that resumes the continuous printing by a usual conveying operation, the continuous printing simultaneously conveying a plurality of sheets in the conveyance path when the jam solution confirming unit determines that the sheets are normally conveyed.

2. The image forming apparatus according to claim 1, further comprising:
a jam detector that detects a sheet jam in the conveyance path based on a detection result by a plurality of sheet detection sensors disposed in the conveyance path;
the print stop unit that stops the image forming operation when the jam detector detects the sheet jam;
a solution operation detector that detects a completion of a solution operation for the sheet jam by a user; and
the jam solution confirming unit that determines whether one sheet is normally conveyed or not by the confirmation conveyance operation when the solution operation detector detects the completion of the solution operation.

3. The image forming apparatus according to claim 1, further comprising:
a humidity detector that detects an atmosphere humidity; and
the print stop unit that stops the image forming operation when the humidity detector detects high humidity equal to or more than a preliminary-specified reference humidity.

4. The image forming apparatus according to claim 1, further comprising:
a sheet feed cassette that houses a plurality of sheets;
a timer unit that measures an unused time length of the sheets housed in the sheet feed cassette; and
the print stop unit that stops the image forming operation using the sheets in the sheet feed cassette upon detection of the unused time equal to or more than the reference time preliminary specified by the timer unit.

5. The image forming apparatus according to claim 1, wherein in the confirmation conveyance operation, the jam solution confirming unit forms an image related to a print job stopped by the print stop unit on a sheet.

6. The image forming apparatus according to claim 1, further comprising:
a sheet holding portion that temporarily holds a sheet whose one surface has been printed in continuous printing where duplex printing is specified; wherein
in the confirmation conveyance operation, the jam solution confirming unit prints another surface of a sheet whose one surface has been printed, subsequent to the one-sided printing.

7. The image forming apparatus according to claim 1, wherein in the confirmation conveyance operation, the jam solution confirming unit determines normal conveyance when a sheet has passed through a detection position of the sheet detection sensor where the sheet jam had been detected by the jam detector.

8. The image forming apparatus according to claim 1, wherein in the confirmation conveyance operation, the jam solution confirming unit conveys a sheet at a speed lower than a sheet conveyance speed in a usual conveying operation.
